(19) United States
(12) Patent Application Publication
(10) Pub. No.: US 2007/0048720 A1
(43) Pub. Date: Mar. 1, 2007

(54) Method and system for providing interactive legal training

(76) Inventor: Barbara P. Billauer, Washington, DC (US)

Correspondence Address: BINGHAM MCCUTCHEN LLP, 3000 K STREET, NW, BOX IP, WASHINGTON, DC, 20007, US

(21) Appl. No.: 11/200,132

(22) Filed: Aug. 10, 2005

(51) Int. Cl. G09B 3/00

(52) U.S. Cl. 434/350

(57) ABSTRACT

A reality-based hypothetical is developed and provided to a set of training participants. The reality-based hypothetical is a fact pattern describing an original lawsuit involving a set of real life scientific studies, data, witnesses, and issues that have never been litigated where only the claims, plaintiff, and defendant are fictitious is a training device for teaching a set of target legal and science objectives, such as determining the scientific integrity of proposed scientific evidence and understanding the scientific evidence as a whole. The “reality-based hypothetical” is developed to provide practice in performing problem solving techniques to determine the “scientific integrity” of proposed scientific evidence and scientific testimony. One or more dialogue sessions are provided to gather information necessary for making a determination on the admissibility of the scientific study. A decision on the admissibility of the scientific study can be rendered during each dialogue session, which occurs at designated segments during the training.

### BACKGROUND OF THE INVENTION

1. Field of the Invention

The present invention relates to a method, computer-based system, computer program product, and simulation game for providing training. More particularly, the present invention relates to a method, a computer-based system, computer program product, and game for providing interactive legal training to a set of legal and policy-making professionals.

2. Description of the Prior Art

A method and mechanism are described herein for teaching the evaluation of scientific evidence as well as decision making techniques to determine admissibility of scientific evidence and/or its applicability to public policy, rulemaking and standard setting. Unlike other courses which use the building block method of study, similar to that used to teach students of the sciences, this method duplicates real-life situations faced by judges and policy makers and tracks thought-processes, analytical methods, and integrative techniques germane to the legal and policy making communities. Thus, rather than focusing on learning the substantive science, problem-solving scenarios which encompass scientific issues are presented for evaluation by a different paradigm. The participants are taught to deconstruct the issues, delineate the points of dispute, identify appropriate legal criteria for resolution, ferret additional information necessary to rule on the soundness of the science, its integrity, relevance, fit and probative value, in accordance with this new methodology as explained in more detail below. Thus, while other courses focus on teaching substantive science in a vacuum, in too short a time period to expect any degree of mastery, competency or retention, this course provides a mechanism to teach the scientific method and to apply it to evaluate various types of scientific evidence without requiring expertise in or mastery of the substantive area itself.

Theoretically, the mechanism of cross-examination should provide complete disclosure of all information necessary for evaluation of scientific evidence. However, this procedure must await the unfolding of a trial which entails taxing courts and the legislative system alike. The law provides various avenues to short-circuit completion of a trial and awaiting a jury verdict. However, judges are hesitant to take advantage of these options, where scientific evidence is involved, because of a lack of comfort in evaluating the scientific evidence. Certainly, where the decision is in equipause or a jury question is presented, the issue must await a jury resolution. However, where testimony or other evidence is predicated on invalid, unreliable and irrelevant science, the legal system provides for, and indeed mandates, that the judge short-circuit the full trial and make a determination at the earliest sustainable juncture. This method provides techniques to allow judges and policymakers to fulfill this requirement by teaching them the analytical techniques thereby giving them the comfort and confidence they need to address scientific evidence at the earliest appropriate juncture.

### SUMMARY OF THE INVENTION

According to the present invention a method, computer-based system, computer program product, and simulation game for providing interactive legal training to judges, legal and policy-making professionals are provided. The interactive legal training of the present invention provides a new formulation of the existing standard for determining evidentiary admissibility of scientific evidence. The interactive legal training provides a mechanism for evaluating, communicating, and determining the scientific reliability, scientific validity, and fitness of scientific evidence. The invention teaches a method of decision-making to determine the admissibility of scientific evidence. The decision-making mechanism is based on a novel method of teaching the scientific method and relating the scientific method to the evidence under consideration. The mechanism teaches how to determine whether the scientific method was properly used in the development of research upon which scientific evidence and testimony is based.

In an embodiment of the present invention, the interactive legal training simulates real-life pre-trial and/or trial proceedings. The simulation can be used by judges, lawyers, policy-makers, or any combination thereof for training tailored to their role in real-life pre-trial and/or trial proceedings. Judges participating in the simulation learn a mechanism of evaluating, communicating, and determining the scientific reliability, scientific validity, and fitness of a scientific evidence as well as understanding the scientific method and evaluating the scientific method's role and use in the development of research upon which the scientific evidence and testimony is based. Lawyers that participate in the simulation can learn a mechanism to support their positions and/or elicit further evidence to sustain their positions for the admission of proposed scientific evidence and expert testimony or expose the lack of “scientific integrity.” As used herein “scientific integrity” means scientific reliability and scientific validity. Policy-makers that participate in the simulation can use the mechanisms to determine the admissibility of proposed scientific evidence and expert testimony under the rules of policy making.

In an embodiment of the present invention, the interactive legal training technique utilizes a novel technique called the “reality-based hypothetical.” The “reality-based hypothetical” is an original fact pattern involving a set of real life scientific studies, authentic data, real expert witnesses and trial lawyers. The issues have never been litigated. Only the claims, plaintiff, and defendant are fictitious. The “reality-based hypothetical” is a novel technique and training device for teaching a set of targeted legal and science objectives, such as determining the scientific integrity of proposed scientific evidence and understanding the scientific evidence as a whole.

The “reality-based hypothetical” is used as the basis for a simulation involving the participants. The simulation is further based on a format for participation. The simulation provides an opportunity to practice decision-making techniques in a real time simulation setting using a format specified by the reality-based hypothetical

In an embodiment of the present invention, the “reality-base hypothetical” provides for information to be disseminated in discrete cohesive portions. Each portion of the “reality-based hypothetical” focuses on a component of the targeted legal and scientific learning objectives. Each discrete portion of information within the “reality-based hypothetical” can be disseminated at segments corresponding to stages of simulated pre-trial and trial proceedings.

In an embodiment of the present invention, a dialogue session can be provided at the conclusion of each simulated segment to allow participants to evaluate the information provided, identify what additional information is needed, determine what rules are available that will provide for eliciting that additional information, and then practice utilizing the methods developed from the rules to render an acceptable decision. The tools and methods needed to elicit the information are explored and taught during the dialogue sessions. A facilitator can direct a dialogue session to ensure that at least some of the information necessary to make the determination is elicited. A decision on the admissibility of the scientific evidence and/or expert testimony can be made at the conclusion of the dialogue sessions, and the decisions recorded.

According to another embodiment of the invention, rather than introducing the information from reality based hypothetical in cohesive segments, the information from the reality based hypothetical may be introduced all at once, may be introduced in a random or haphazard fashion as in a typical trial or pre-trial proceeding, or in any other convenient manner.

### BRIEF DESCRIPTION OF THE DRAWINGS

The above described features and advantages of the present invention will be more fully appreciated with reference to the detailed description and appended figures in which:

FIG. 1 depicts an exemplary flow chart of a method of performing interactive legal training judges, legal and policy-making professionals according to an embodiment of the present invention; and

FIG. 2 depicts an exemplary block diagram of a system in which the present invention can find application.

### DETAILED DESCRIPTION OF THE INVENTION

To facilitate a description of the invention, a glossary of terms is provided.

### Glossary of Terms

Scientific Reliability: the degree of stability exhibited when a measurement is repeated under identical test or study conditions; duplicatability of results when a test or experiment is performed under similar (virtually identical) conditions; precision of data; repeatability of results (repeatability of results).

Scientific Validity: the extent to which a measurement, test or study accurately measures what it purports to measure; scientific accuracy or “truth;” conclusions bearing a logical nexus to establish scientific knowledge; research which is internally valid, externally valid, and generalizible.

Scientific Integrity: Scientific Reliability and Scientific Validity.

Reality-Based Hypothetical: is an original fact pattern presenting a set of real life scientific studies, authentic data, real expert witnesses, trial lawyers, and issues that have never been litigated. Only the plaintiff and defendant are fictitious.

Participant: an individual who takes part in any interactive legal training activity.

Facilitator: an individual who directs a dialogue session of the interactive legal training.

Trainee: an individual who takes part in training to learn and understand the relationship between legal principles and scientific principles.

Judge Trainee: a judge who takes part in training to learn and understand the relationship between legal principles and scientific principles to be able to elicit information with which to render a decision on the admissibility of a scientific study, or parts thereof.

Lawyer Trainee: a lawyer who takes part in training to learn and understand the relationship between legal principles and scientific principles to be able to provide legal arguments regarding the admissibility of a scientific study, or parts thereof.

Witness: an individual who takes part in training to provide expert testimony related to the case.

Tools: information relevant to understanding the relationship between legal principles and scientific principles.

The present invention is now described more fully hereinafter with reference to the accompanying drawings that show embodiments of the present invention. The present invention, however, may be embodied in many different forms and should not be construed as limited to embodiments set forth herein. Appropriately, these embodiments are provided so that this disclosure will be thorough and complete, and will fully convey the scope of the present invention.

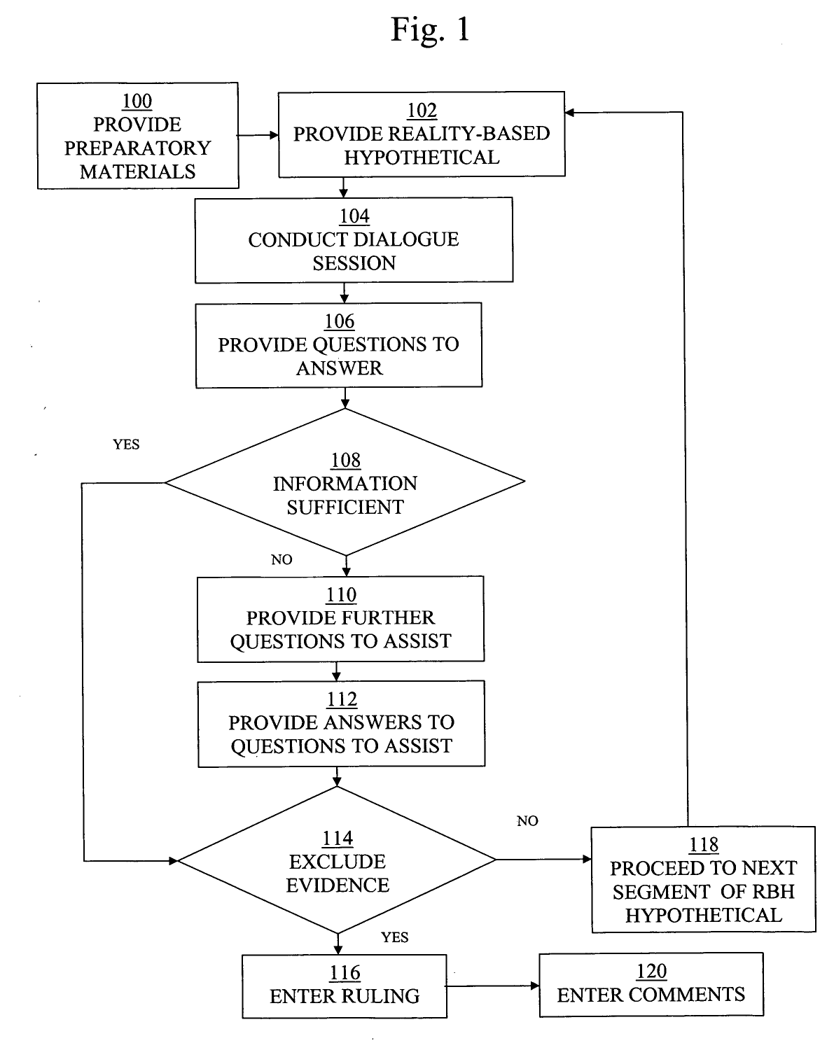

FIG. 1 depicts an exemplary flow chart for providing interactive legal training to participants including a judge, a lawyer, and a policy-maker, or any combination thereof. In. In the FIG. 1 embodiment of the present invention, the method begins in step 100. In step 100, preparatory materials are provided. The preparatory materials summarize the targeted legal and science objectives of the interactive legal training in an story or anecdotal format.

In step 102, information in a portion of a reality-based hypothetical is provided. In an embodiment of the present invention, information in each portion of the reality-based hypothetical can be provided on a subset of cards in a set of cards. The subset of cards can be designated with some characteristic, such as color, that reflects the segment corresponding to the stage of simulated pre-trial and trial proceedings for which it is applicable. The cards can indicate the participants that is allowed to interact with them. In an embodiment of the present invention, information in each portion of the reality-based hypothetical can be provided in a section of an interactive training system organizer. Each section of the interactive training system organizer can be separated by section identifiers and provided with a portion of the reality-based hypothetical. The section of an interactive training system organizer for each portion of the reality-based hypothetical can be designated with some characteristic, such as color, that reflects the segment corresponding to the stage of simulated pre-trial and trial proceedings for which it is applicable and how each of the types of participants are allowed to interact with it.

In an embodiment of the present invention, each portion of the reality-based hypothetical to be used during a segment of the trial or pre-trial activity can be provided in a window on the display of a computer system. A window can be provided for each type of participant of the interactive legal training system and designated with some characteristic to signify the type of participant to which the window corresponds. Information in each portion of the reality-base hypothetical can be displayed, at the appropriate segments of the trial, in the window of the type of participant to which it is associated. The user can interact with each window through the selection of one or more objects displayed on the display as directed by the system.

In step 104, a dialogue session is conducted. In an embodiment of the present invention, the dialogue session includes at least one participant writing down information related to the portion of the reality-based hypothetical. In an embodiment of the present invention, the information is entered on an information card. The information card can include a set of areas for entering the information, providing questions to be considered, and set of tutorials on one or more of the scientific principles applicable to the scientific study. The set of areas for entering information include, but are not limited to, the segment of trial or pre-trial activity that the information is related to, comments related to the portion of the reality-based hypothetical, identified issues, admissibility of testimony based on at least one scientific study additional information desired to make a determination on the admissibility of testimony based on the scientific study, or parts thereof, rational, a set of specific questions to assist in identifying what legal principles and scientific principles should be applied to the reality-based hypothetical. In an embodiment of the present invention, the information is entered in a section of the interactive training system organizer reserved specifically for entering information. The section of the interactive training system organizer can include the set of areas for entering information. In an embodiment of the present invention, the information is entered in an information window. The information window can include the set of areas for entering information.

In step 106, a set of questions to be answered are identified. In an embodiment of the present invention, the answers can be provided on a card. The card for each segment can be designated with some characteristic, such as color, that reflects the segment corresponding to the stage of simulated pre-trial and trial proceedings for which it is applicable, and indicates the participant that is allowed to interact with it. In an embodiment of the present invention, the answers can provided in a section of an interactive training system organizer. The section of an interactive training system organizer for each segment can be designated with some characteristic, such as color, that reflects the segment corresponding to the stage of simulated pre-trial and trial proceedings for which it is applicable and how a participant is allowed interact with it. In an embodiment of the present invention, the answers can be provide in a respective window on the display of a computer system.

In step 108, it is determined whether the information provided by the information in the portion of the reality-based hypothetical is sufficient to make a determination as to the admissibility of the scientific evidence. In an embodiment of the present invention, the method includes providing the additional information in the form of an affidavit. If so, the method proceeds to step 114. If not, the method proceeds to step 110.

In step 110, further questions to assist in making a determination as to the admissibility of the scientific evidence are provided. In an embodiment of the present invention, the questions are provided on a question card. The question card can be designated with some characteristic that the segment corresponding to the stage of simulated pre-trial and trial proceedings for which it is applicable, and the one or more participants that are allowed to interact with it.

In an embodiment of the present invention, the questions is provided in a question section of the interactive training system organizer. The questions can be provided to one or more of the participants, such as lawyer trainee or judge trainee by one or more participants, such as a facilitator. The question section of the interactive training system organizer can be associated with the portion of the reality-based hypothetical for a segment. The question section of the interactive training system organizer can be designated with some characteristic that reflects that it is associated with the section of the interactive training system organizer for the portion of the reality-based hypothetical, and the type of participant that is allowed interact with it.

In an embodiment of the present invention, the questions is provide in a window of the display of a computer system. In an embodiment of the present invention, the set of questions can be provided in a window specifically for questions. In an embodiment of the present invention, the set of questions can be provided in a window corresponding to one or more of the participants in the interactive training system.

In step 112, an answers to the set of questions to assist in determining the admissibility of the scientific study is provided. In an embodiment of the present invention, the basic principles and language necessary to understand experts use of scientific terms are identified. In an embodiment of the present invention, the answers are provided to a set of judge participants. In an embodiment of the present invention, the answers are provided by a witness participant. In an embodiment of the present invention, the answers are provided on an answer card. In an embodiment of the present invention, the answers are provided on in an answer section of a plurality of sections of the interactive training system organizer associated with the portion of the reality-based hypothetical. In an embodiment of the present invention, the answers are provide in a window of a display of a computer system. In an embodiment of the present invention, the answer can be provided in a window specifically for answers. In an embodiment of the present invention, the answer can be provided in a window corresponding to one or more of the participants in the interactive training system.

In step 114, a determination is made whether to exclude scientific evidence, such as testimony. If so, the process proceeds to step 116 where a decision as to the admissibility of the scientific evidence is entered. In an embodiment of the present invention the decision is provided on a decision card or sheet, or by selection of an object in a window of a display. If not, the process proceeds to step 118. In step 118 participants proceed to the next portion of the “reality-based hypothetical.” In step 120, comments are provided and entered on a comment form.

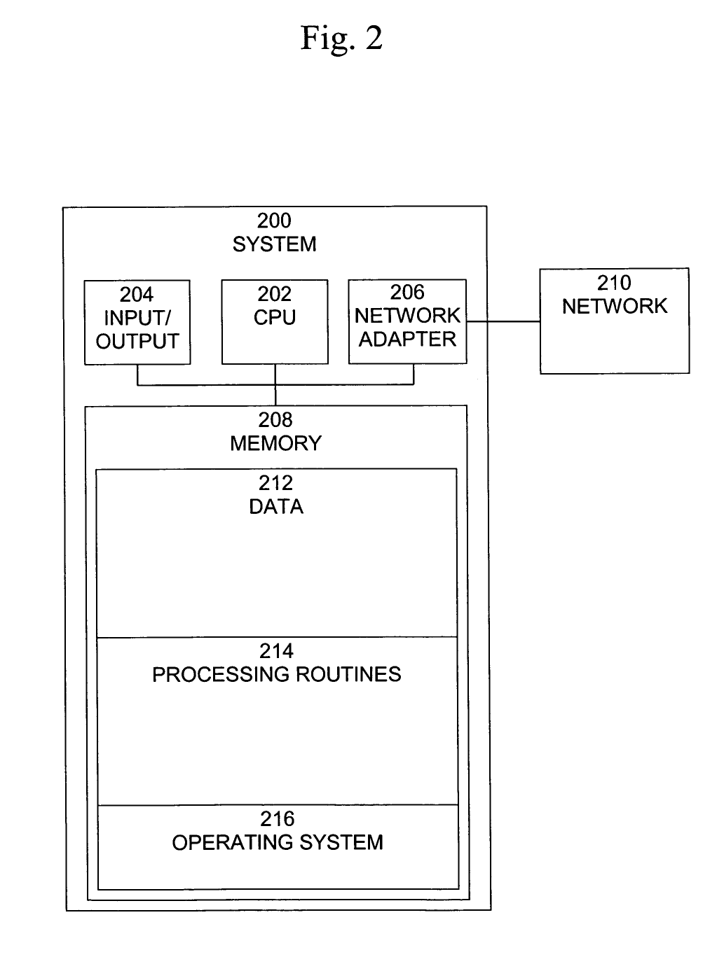

An exemplary block diagram of a system in which the present invention can find application is shown in FIG. 2. System 200 is typically a programmed general-purpose computer system, such as a personal computer, workstation, and minicomputer or mainframe computer. System 200 includes processor (CPU) 202, input/output circuitry 204, network adapter 206, and memory 308. CPU 202 executes program instructions in order to carry out the functions of a system 200 in accordance with the present invention. Typically, CPU 202 is a microprocessor, such as an INTEL PENTIUM® processor, but may also be a minicomputer or mainframe computer processor. Input/output circuitry 204 provides the capability to input data to, or output data from, system 200. For example, input/output circuitry may include input devices, such as keyboards, mice, touchpads, trackballs, scanners, etc., output devices, such as video adapters, monitors, printers, etc., and input/output devices, such as, modems, etc. Network adapter 206 interfaces system 200 with network 210. Network 210 may be any standard local area network (LAN) or wide area network (WAN), such as Ethernet, Token Ring, the Internet, or a private or proprietary LAN/WAN. In an embodiment of the present invention, the system 200 can use network 210 to receive remote interactive legal science training. In an embodiment of the present invention, the system 200 can communicate with other systems over network 210 to participate in real-time interactive legal science with users of the other systems. The users of the other systems can be trainee participants.

Memory 208 stores program instructions that are executed by, and data that are used and processed by, CPU 202 to perform interactive legal science training of the present invention. Memory 208 may include electronic memory devices, such as random-access memory (RAM), read-only memory (ROM), programmable read-only memory (PROM), electrically erasable programmable read-only memory (EEPROM), flash memory, etc., and electromechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

Memory 208 includes data 212, interactive training processing routines 214, operating system 216, and data structure 218. Data 212 includes data used by the present invention. Interactive training processing routines 214 are routines that implement the functions of the present invention. Operating system 216 provides overall system functionality.

While specific embodiments of the present invention have been illustrated and described, it will be understood by those having ordinary skill in the art that changes can be made to those embodiments without departing from the spirit and scope of the invention.

What I claim is:

1. A method of providing interactive legal training comprising:
developing a reality-based hypothetical, having predetermined segments, that focuses on targeted learning objectives;
providing a format for participants to engage in a simulation of the reality based hypothetical;
identifying whether the information provided in a completed predetermined segment is sufficient to reach a decision on at least one issue portrayed in the reality based hypothetical;
evaluating and practicing methods of procuring additional information according to the legal rules of evidence through dialog sessions conducted at the conclusion of the predetermined segments within the reality based hypothetical;
providing a mechanism for decision making on issues presented in the reality based hypothetical through dialog sessions conducted at the conclusion of the predetermined segments within the reality based hypothetical; and
providing a format and an opportunity for definitive decision making on at least one of the issues by one or more participants which can be evaluated.

2. A system for providing interactive legal training comprising:
a processor operable to execute computer program instructions; and
a memory operable to store computer program instructions executable by the processor, for performing the steps of:
providing during a segment of the interactive legal training a portion of the reality-based hypothetical that focuses on a component of the targeted legal objective and a component of the targeted scientific learning objective;
conducting a dialogue session at the conclusion of the segment of the interactive legal training to assess the portion of the reality-based hypothetical;
determining whether to exclude scientific evidence based on information from the portion of the reality-based hypothetical;
if so, entering a ruling; and
otherwise, proceeding to a next segment of the interactive legal training and providing a next portion of the reality-based hypothetical;
wherein the reality-based hypothetical focuses on a targeted legal learning objective and a targeted scientific learning objective.

3. A computer program product for providing interactive legal training comprising:
a computer readable medium;
computer program instructions, recorded on the computer readable medium, executable by a processor, for performing the steps of:
providing during a segment of the interactive legal training a portion of the reality-based hypothetical that focuses on a component of the targeted legal objective and a component of the targeted scientific learning objective;
conducting a dialogue session at the conclusion of the segment of the interactive legal training to assess the portion of the reality-based hypothetical;
determining whether to exclude scientific evidence based on information from the portion of the reality-based hypothetical;
if so, entering a ruling;
otherwise, proceeding to a next segment of the interactive legal training and providing a next portion of the reality-based hypothetical;
wherein the reality-based hypothetical focuses on a targeted legal learning objective and a targeted scientific learning objective.

4. A method of providing interactive legal training comprising:
an interactive training organizer having a plurality of sections, each section including having a different section identifier and an area for recording a decision on the admissibility of scientific evidence having a plurality of sub-areas, each sub-area relating to a different type of information and having a different identifying color; and
at least one document storage unit separate and apart from interactive training organizer corresponding to each of the subsections in the plan book and the storage units each having the same identifying color as its corresponding plan book subsection;
providing a portion of the reality-based hypothetical that focuses on at least one of a component of the targeted legal objective and a component of the targeted scientific learning objective during a segment of the interactive legal training;
conducting a dialogue session at the conclusion of the segment of the interactive legal training to access the portion of the reality-based hypothetical;
determining whether to exclude scientific evidence based on information from the portion of the reality-based hypothetical;
if so, entering a ruling;
otherwise, proceeding to a next segment of the interactive legal training and providing a next portion of the reality-based hypothetical;
developing a reality-based hypothetical that focuses on a targeted legal learning objective and a targeted scientific learning objective.
